(19) United States
(12) Patent Application Publication
(10) Pub. No.: US 2009/0128506 A1
(43) Pub. Date: May 21, 2009

(54) Electronic Device with Touch Sensitive Input

(76) Inventor: Mikko Nurmi, Tampere (FI)

Correspondence Address: Hollingsworth & Funk, LLC, 8009 34th Avenue South, Suite 125, Minneapolis, MN, 54425, US

(21) Appl. No.: 11/992,931

(22) PCT Filed: Sep. 30, 2005
(86) PCT No.: PCT/FI2005/050341

§ 371 Date: Mar. 28, 2008

(51) Int. Cl. G06F 3/041

(52) U.S. Cl. 345/173

(57) ABSTRACT

The present invention relates to an electronic device comprising a control unit, a display, a body portion, and a touch sensitive area outside the display. According to an aspect of the invention, the touch sensitive area is arranged such that there is a level difference between the surface of the body portion and the surface of the display. The control unit is arranged to detect an input to the touch sensitive area (506), and the control unit is arranged to perform a software function associated with the touch sensitive area (508).

### FIELD OF THE INVENTION

The present invention relates to an electronic device with touch sensitive input.

### BACKGROUND OF THE INVENTION

The significance of different displays is becoming more and more important in portable electronic devices. The browsing capabilities of these devices are improving. Portable devices are increasingly used when navigating in different application views shown in the devices, for example. Browsing on the Internet is one example where the usability of a display is of critical importance. However, different portable electronic devices are limited by size, and therefore also the sizes of the displays used in such devices are usually considerably smaller than those used in personal computers, for example. Further, the space for a keypad is very limited and if the size of the display is desired to be as large as possible, it is necessary to use for a display at least part of the electronic device space typically reserved for a keypad.

Touch screens are used in many portable electronic devices, for instance in PDA (Personal Digital Assistant) devices and mobile devices. Touch screens are operable by a pointing device (or stylus) and/or by finger. Typically the devices also comprise conventional buttons for certain operations.

U.S. Pat. No. 6,005,549 discloses a user interface apparatus with a touch screen and selectable regions also outside the display, for instance in FIG. 17. In FIGS. 26 and 27 an embodiment is disclosed in which around the display (including a detector area) there is a berm which is solely used for confining a body member of a user or a pointing device to the detector area.

### SUMMARY OF THE INVENTION

There is now provided an enhanced solution for arranging touch sensitive areas in electronic devices. This solution may be achieved by electronic devices, a module and a user interface for an electronic device, which are characterized by what is stated in the independent claims. Some embodiments of the invention are disclosed in the dependent claims.

A starting point for the invention is an electronic device comprising a control unit for controlling functions of the electronic device, a display, a body portion, and a touch sensitive area outside the display. According to an aspect of the invention, the touch sensitive area is arranged such that there is a level difference between the surface of the body portion and the surface of the display. The control unit is arranged to detect an input to the touch sensitive area, and the control unit is arranged to perform a software function associated with the touch sensitive area. The association between the touch sensitive area and the software function is to be understood broadly to refer to any type of direct or indirect relationship defined between the touch sensitive area and the software function. For instance, the association may be obtained on the basis of binding data between the software function and a detector belonging to the touch sensitive area.

According to an embodiment of the invention, the touch sensitive area is associated with a shortcut to a view and/or an application. The electronic device is configured to display the view and/or to initiate the application in response to detecting the input to the touch sensitive area.

According to an embodiment of the invention, the control unit is arranged to determine the software function in response to entering or to a need to enter an operating state enabling detection of inputs to the touch sensitive area. The control unit is arranged to associate the determined software function with the touch sensitive area and monitor inputs to the touch sensitive area. The control unit may remove the association in response to ending or exiting the operating state enabling detection of inputs to the touch sensitive area.

The embodiments of the invention provide several advantages. Space is saved since also the area between the display and the body portion creating the level difference may be used for obtaining inputs from the user. For instance, an operation typically associated with a separate button may now be provided in the touch sensitive area between the display and the body portion. When the display is operated by a pointing device, usability of the device may be enhanced since the user can select a desired operation by the pointing device instead of pressing the button by the other hand or releasing the pointing device. There are many possibilities how and which software functions are associated with the touch sensitive area. For instance, a user may define a personal shortcut to be associated with the touch sensitive area on the border of the screen earlier not effectively used, possibly regardless of the mode of the electronic device. The user may then quickly enter a view defined in the shortcut simply by touching the touch sensitive area.

### BRIEF DESCRIPTION OF THE DRAWINGS

In the following, the invention will be described in greater detail with reference to exemplary embodiments and the accompanying drawings, in which

FIG. 1 shows an example of an electronic device;

FIG. 2 illustrates a simplified cut away view of an electronic device according to an embodiment of the invention,

FIGS. 3a to 3f illustrate exemplary cut away views of an electronic device according to some embodiments of the invention;

FIGS. 4a to 4c illustrate some exemplary front views of electronic devices; and

FIG. 5 shows an example of a method according to an embodiment of the invention.

### DETAILED DESCRIPTION OF SOME EMBODIMENTS OF THE INVENTION

The embodiments of the invention are applicable to a wide variety of electronic devices, such as a mobile station used as a terminal in telecommunication systems comprising one or more base stations. The device may be used for short-range communication implemented with a Bluetooth chip, an infrared or WLAN connection, for example. The portable electronic device may be a PDA (Personal Digital Assistant) device including the necessary telecommunication means for establishing a network connection, or a PDA device that can be coupled to a mobile telephone, for instance, for a network connection. The portable electronic device may also be a laptop or desktop computer, an accessory device, or a computing device including no telecommunication means. To name some further examples, the electronic device could be a browsing device or a game console.

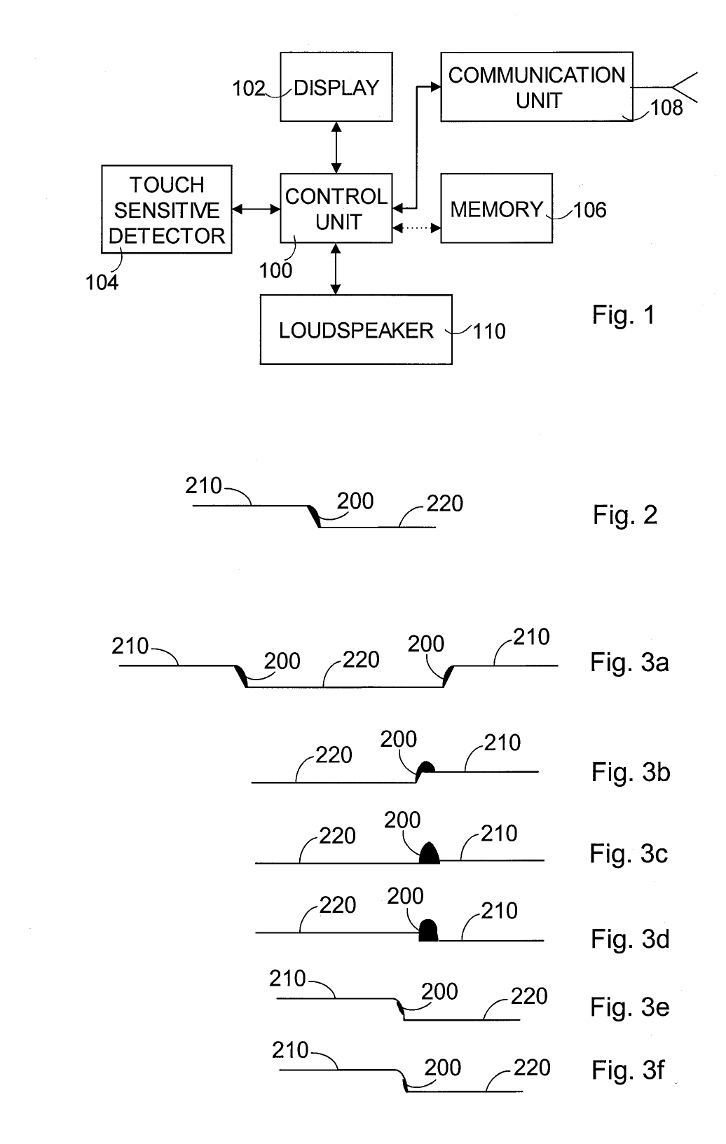

FIG. 1 shows a block diagram of the structure of an electronic device in which the present invention is applicable. A control unit 100, typically implemented by means of a microprocessor and software or separate components, controls the basic functions of the device. A user interface of the device comprises an input device 104, in this embodiment a touch sensitive detector, audio output means including a loudspeaker 110, and a display 102. In addition, the user interface of the device may include other parts such as a microphone, a speech recognizer, a speech synthesizer, and/or a keypad part. Depending on the type of the device, there may be different and a different number of user interface parts. The device of FIG. 1, such as a mobile station, also includes communication means 108 that implement the functions of a mobile station and include speech and channel coders, modulators and RF parts. The device may also comprise an antenna and a memory 106.

The control unit 100 controls at least some functions of the electronic device. Computer program codes executed in a processing unit of the electronic device may be used for causing the electronic device to implement the control unit 100 and in general the means for providing inventive functions relating to inputs to a touch sensitive area in the electronic device, some embodiments of the inventive functions being illustrated below. Computer program codes can be received via a network and/or be stored in memory means, for instance on a disk, a CD-ROM disk or other external memory means, wherefrom they can be loaded into the memory 106 of the electronic device. The computer program can also be loaded through a network by using a TCP/IP protocol stack, for instance. Hardware solutions or a combination of hardware and software solutions may be used to implement the inventive functions.

A hardware module or a specific user interface element for the electronic device may, in one embodiment, be applied to embody the inventive features illustrated below. The hardware module comprises connecting means for connecting the electronic device mechanically and/or functionally. Thus, the hardware module may form part of the device and could be removable. For instance, such hardware module could be a sub-assembly or an accessory. The hardware module or the user interface comprises a touch sensitive area to be arranged between a body portion and a display of the electronic device to provide a level difference. In another embodiment the hardware module or the user interface further comprises the body portion and/or the display. The hardware module or the user interface element may comprise a detector for receiving inputs to the associated touch sensitive area and for indicating received inputs to a control unit of the device.

Inputs from the user of the electronic device are received by the touch sensitive display 102 and by means of the touch sensitive detector 104. As will be illustrated in more detail later, the touch sensitive detector 104 may be applied to detect inputs to a touch sensitive area between the display 102 and a body portion of the electronic device. The control unit 100 is connected to the display 102 and configured to control different application views on the display 102. Inputs detected by the touch sensitive detector 104 are delivered to the control unit 100. The control unit 100 determines one or more associated software actions associated with the detected input to the touch sensitive detector 104, and performs these software functions. For instance, as a result of the performed software functions, an appropriate (updated) view is displayed on the display 102 and possible other appropriate functions are performed.

A broad range of software functions may be associated with the touch sensitive detector 104 to detect inputs to the associated touch sensitive area. For instance, user inputs for navigating in different operating modes of the electronic device, such as navigating in menu structures or in application views, may be associated with the touch sensitive detector 104. The touch sensitive detector 104 and the control unit 100 may thus be configured to provide navigation means for navigating through a plurality of available user interface input options.

In the present embodiment the touch sensitive detector 104 is configured to detect an input to a touch sensitive area (or is a part thereof) outside the display 102. FIG. 2 illustrates a simplified cut away view of an electronic device according to an embodiment. In the present embodiment a touch sensitive area 200 is arranged such that there is a level difference between the surface of a body portion 210 of the electronic device and the surface of the display 220. It is to be noted that in the context of the present application, the surface of the display 220 may refer to a surface of a covering portion, such as a transparent window, providing protection to the actual display element. The surface of the body portion 210 may in one embodiment be a surface of a removable casing. The main direction of the surface of the touch sensitive area 200 is substantially different from that of the body portion 210 and/or the display 220. The touch sensitive area 200 may be arranged at least partly providing the level difference. Some portion of the touch sensitive area 200 may also be arranged essentially at the level of the body portion 210 and/or the display 220 (in the example of FIG. 2 the touch sensitive area 200 could further extend horizontally). It is to be noted that there may be one or more touch sensitive areas 200 arranged between the body portion 210 and the display 220.

There are many different technologies by which the touch sensitive area 200 and the touch sensitive detector 104 may be implemented. For instance, an already known touch screen technology may be applied. Resistive touch screen technologies, capacitive technologies, inductive technologies, or surface wave based technologies may be applied, but the application is not limited to any specific touch sensitive input detection technology.

FIGS. 3a to 3f illustrate cut away views of some embodiments of arranging the touch sensitive area 200 between the body portion 210 and the display 220. As illustrated in these Figures, the level difference may be arranged in many different ways and the touch sensitive area 200 may also serve to limit the movement of a pointing device, i.e. limit the pointing device essentially within the display area when the pointing device contacting the display is moved towards the body portion 210 of the electronic device. The provision of the touch sensitive area 200 is not limited to the examples in FIGS. 3a to 3f. Different forms of the touch sensitive area 200 may be applied, for instance the surface of the touch sensitive area 200 may be flat or concave. Also the angle between the touch sensitive area 200 the body portion/the display 220 may be varied as appropriate.

According to an embodiment, the touch sensitive area 200, the body portion, and/or the display 220 may comprise guidance means further facilitating the use of the touch sensitive area 200. For instance, a cavity, a channel, and/or a berm may be applied for guiding a pointing device or a finger. In one embodiment the guiding means is located on the touch sensitive area 200 such that it is easier to locate the pointing device to the touch sensitive area 200. In another embodiment a berm is arranged between the touch sensitive area 200 and the display in order to avoid accidental inputs to the touch sensitive area 200.

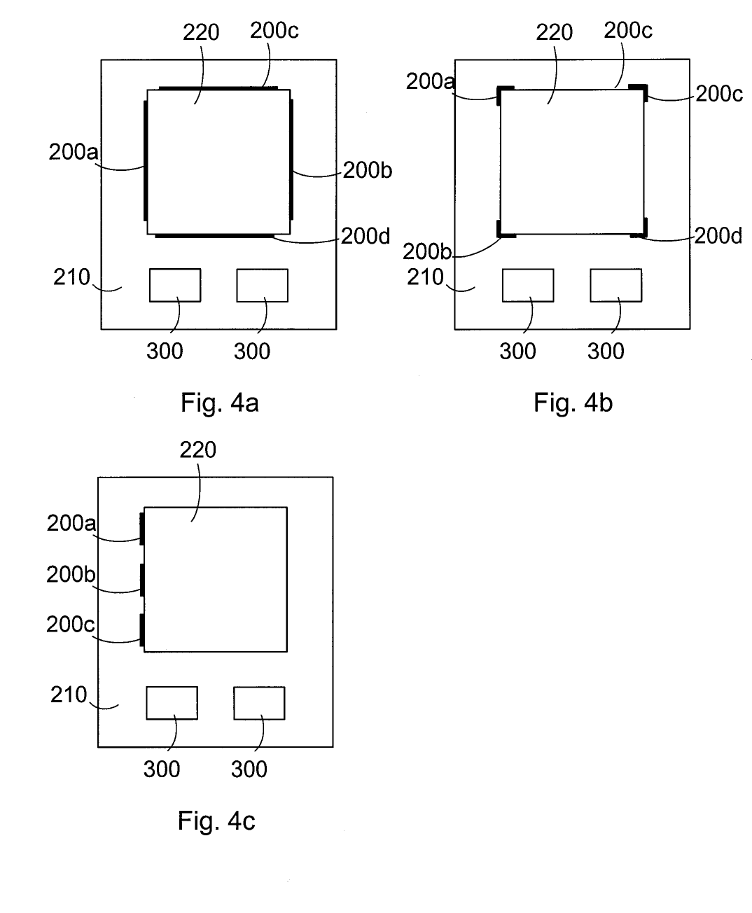

FIGS. 4a to 4c illustrate some exemplary and simplified front views of electronic devices. References 200a to 200d represent separate touch sensitive areas, each of which may be associated with a specific software function (it is also possible to associate the same software function to multiple touch sensitive areas). As shown, touch sensitive areas 200a to 200d may be positioned on the sides of the display 220 and/or in the corners of the display 220. Typically the electronic device also comprises buttons 300. It is to be noted that the application of the present invention is not limited to any specific configuration of the touch sensitive areas 200a to 200d around the display. There may be any number of touch sensitive areas 200 and the features illustrated in FIGS. 4a to 4c may be combined.

Referring to FIGS. 4a to 4c, some exemplary interaction arrangements are illustrated in the following. Applicable input methods include for example: contact (at least one) the touch sensitive area 200 with pointing means (a stylus or a finger), move the pointing means from the display 220 to the touch sensitive area 200, the contact to the touch sensitive area 200 is maintained with the pointing means for a predetermined time period, the pointing device is moved within the touch sensitive area 200 or to the screen 220. Also a combination of the above mentioned input methods may be applied.

According to an embodiment, a specific action may be initiated by selecting a target, for instance an icon, on the screen 220, and moving the pointing means to the touch sensitive area 200 such that the target is dragged (contact to the screen 220 is maintained). For instance, a copy operation may be associated with the touch sensitive area 200, and in this example the target may be copied in response to the user dragging the target to the touch sensitive area 200. Further, specific actions may be associated with an input moving the pointing means from edge-to-edge, or between two touch sensitive areas 200, for instance.

According to an embodiment, only a portion of the available touch sensitive area 200 is used for detecting inputs at a time. The control unit 100 may determine the currently applied area in step 500. There may be application and/or usage context specific settings stored in the memory 206 on the basis of which the control unit 100 determines the currently monitored portions of the touch sensitive area 200. Hence, it is possible to change the areas used for detecting inputs to the touch sensitive area 200 between different views to best suite current use situations.

A single specific software function may be associated with a touch sensitive area 200. In an alternative embodiment a plurality of software functions may be associated with the touch sensitive area 200. In this embodiment the association may be changed according to a current operating state of the electronic device. For instance, associations may be application specific, menu specific, or view specific. The device may also be set to different operating modes or profiles, and these different profiles may have different associations. For instance, during a “Work” profile the touch sensitive area 200 is associated with a function activating a calendar application, whereas during a “Free time” profile the touch sensitive area 200 is associated with a function activating a browser application. An applicable association may be determined and changed automatically by the control unit 100. When an application view or a currently displayed menu changes, the function associated with the input to the touch sensitive area 200 may be changed. For instance, in a certain view it may be desirable to arrange a “Select” button by the area 200a in FIG. 4a, whereas in some other view there should be no activities selectable on the left border of the touch sensitive area 200, but the “Select” button is provided only by the area 200c in FIG. 4a. It is to be noted that one or more portions of the touch sensitive area 200 may be set to represent a particular action regardless of the current operating state of the electronic device.

The control unit 100 may be configured to update the association between the software function and the touch sensitive area. In one embodiment an association is changed or a new association and/or a new active area is specified between a software function and the touch sensitive area 200 on the basis of a further check or a condition. The change of an association may involve a change of a software function and/or (an active area of) the touch sensitive area 200 defined in the association. Hence, the control unit 100 may be arranged to store to the memory 106 binding information on the newly defined association between the touch sensitive area 200 and a software function, possibly replacing an earlier association in the memory 106. Thereafter, when necessary, the control unit 100 is arranged to define the association on the basis of the stored binding information.

In one further embodiment the applied association is redefined on the basis of an input from a user of the electronic device. The association may in one embodiment be changed on the basis of an action for an object on the display. For instance, the touch sensitive area 200 may first be associated with a shortcut to an application. When a user selects a file identified on the display, the control unit 100 may be arranged to update a copy action as a new function associated with the touch sensitive area 200. The association could further be defined on the basis of the action exerted on the object, for instance specific actions for selecting the object and for dragging the object.

In another embodiment the newly defined association is defined on the basis of a check performed by the control unit or an input from another entity, for instance from another application. For instance, the control unit 100 may be configured to re-determine the association in response to detecting that an application reaches a specific state.

As already mentioned, a user may specify a function associated with the touch sensitive area 200. A settings menu may be provided by which the user can select a function to be associated with the touch sensitive area 200, possibly in a certain application or a usage context. The association defined by the user may be stored in the memory 106 and the control unit 100 may apply the already illustrated features also applying this user specified association. Thus, the user could make shortcuts to his/her desired views or functions such that these shortcuts are always available and do not require space on the display 220 or keypad. In a further embodiment the associations are user specific and selected on the basis of a user identifier detected when activating the device, for instance. As an example, the user could determine that a calendar view can always be selected/activated by an input to the touch sensitive area 200c of FIG. 4b.

According to an embodiment, the user may define which portions of the available touch sensitive area 200 are to be used for detecting inputs, on the basis of which the control unit 100 may set the controlled areas of the touch sensitive area 200. These definitions may also be user and/or device profile specific and stored in a user specific profile. These embodiments facilitate that the user interface and the usage of the touch sensitive area 200 may be customized to meet the needs of different users.

The software function or an action related thereto and associated with the touch sensitive area 200 may be indicated to the user on the display 220 and/or the body portion. The function may be indicated when the function is available by the touch sensitive area 200 and/or when an input to the touch sensitive area 200 has been detected. There may be an area reserved on the display 220 for this indication close to the touch sensitive area 200. Also the body portion 210 may include an indicator that can be updated to show the current function available or selected by the touch sensitive area 200. If the space of the touch sensitive area 200 is adequate, the indication may be provided also on the touch sensitive area 200. There are many possibilities how this indication may be done; one way is to display text next to the touch sensitive area 200 indicating the currently available function. The control unit 100 may be configured to perform this indication on the basis of the determination of the current function. If the function is always the same for the touch sensitive area 200, for instance “select”, the indication may be marked permanently on the body portion 210 next to the touch sensitive area 200. Other indication techniques that may be applied include for example: specific visualisation of the touch sensitive area 200 (for instance, lighting, highlighting or specific colours, shade or darkness of the touch sensitive area, etc.), specific icons, or even audio feedback (for instance when an input to or near the touch sensitive area 200 is detected). If the size of the touch sensitive area 200 is adequate, the indication of the function could be positioned on the touch sensitive area 200.

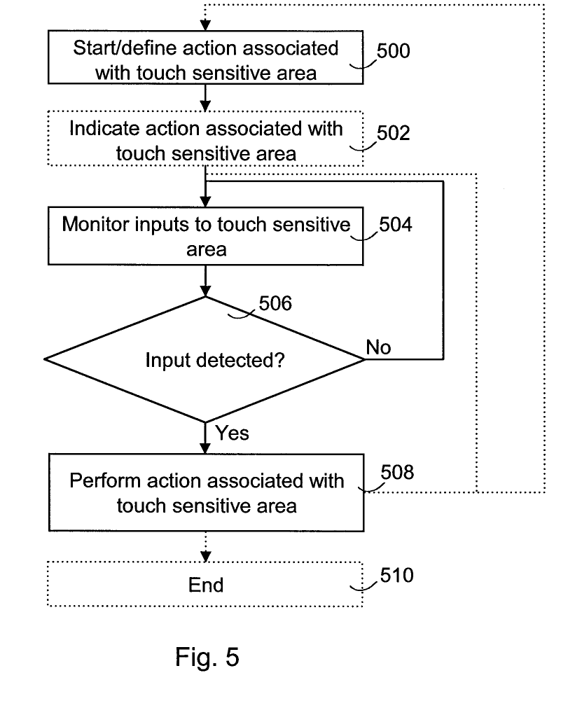

FIG. 5 shows an example of an operation method of the electronic device according to an embodiment of the invention. The method starts in step 500, whereby a software function currently associated with the touch sensitive area 200 may be determined. The software function to be associated with the touch sensitive area 200 may be determined on the basis of pre-stored binding information or on the basis of a user input.

Step 500 may be entered, for instance, when a specific application, an application view or a menu view is entered in which the touch sensitive area 200 is used as an input method. Thus, the control unit 100 may be arranged to determine the associated software function in response to entering or to a need to enter an operating state enabling detection of inputs to the touch sensitive area 200. Typically this step is entered in response to an input from the user. The control unit 100 may be arranged to associate the determined software function with the touch sensitive area in question and store the association in the memory 106 (not shown in FIG. 5). In step 502, the function available by touching the touch sensitive area 200 is indicated to the user, for instance on a display portion next to the touch sensitive area 200. It is to be noted that this step may be omitted, for instance if the indication is permanently available on the body portion 210 of the electronic device.

In steps 504 and 506 inputs to the touch sensitive area are monitored. If an input is detected, the associated software function is performed. As already mentioned, this step may involve one or more different functions depending on the implementation of the operation logic of the electronic device. For instance, the view on the display 102 may be updated. The monitoring 504 may be continued after step 508 or the method may be ended 510. Hence, in one embodiment the control unit 100 is arranged to remove the association as a response to ending or exiting the operating state enabling detection of inputs to the touch sensitive area. It is also feasible that another touch sensitive area 200 is activated for use or that the association of the current touch sensitive area 200 is changed as a result of step 508. As already mentioned, the input associated with the touch sensitive area 200 may also be indicated for the user. In this embodiment step 500 may be entered and the association be removed and/or updated. The dashed lines illustrate these alternatives after step 508 in FIG. 5.

The above-illustrated embodiments are only exemplary and also other implementation possibilities exist. For instance, instead of the embodiment illustrated in FIG. 5, the associated software function may be defined only after detecting an input to the touch sensitive area 200. In another embodiment, the touch sensitive area 200 may have a closer relationship to the display 102, for instance such that the touch sensitive detector 104 is connected to the display 102 or a display control unit. Since the touch sensitive area 200 may be implemented by applying touch screen technology, it is to be noted that the touch sensitive area 200 may thus be considered as part of the overall display: however the touch sensitive area 200 provides the level difference between a body portion of the electronic device and a portion of the display 102.

Even though the invention has been described above with reference to an example according to the accompanying drawings, it is clear that the invention is not restricted thereto but can be modified in several ways within the scope of the appended claims.

1. An electronic device comprising a control unit for controlling functions of the electronic device, a display, a body portion, and a touch sensitive area outside the display, wherein
the control unit is arranged to detect an input to the touch sensitive area,
the control unit is arranged to perform a software function associated with the touch sensitive area, and
the touch sensitive area is arranged between the body portion and the display for providing a level difference between the surface of the body portion and the surface of the display, wherein the main direction of the surface of the touch sensitive area is substantially different from that of the body portion and/or the display.

2. An electronic device according to claim 1, wherein the control unit is arranged to determine the software function in response to entering or to a need to enter an operating state enabling detection of inputs to the touch sensitive area,
the control unit is arranged to associate the determined software function with the touch sensitive area, and
the control unit is arranged to remove the association in response to ending or exiting the operating state enabling detection of inputs to the touch sensitive area.

3. An electronic device according to claim 1, wherein the touch sensitive area is associated with a shortcut to a view and/or an application, and
the control unit is configured to display the view and/or to initiate the application as a response to detecting the input to the touch sensitive area.

4. An electronic device according to claim 1, wherein the control unit is arranged to determine or update the software function on the basis of or during at least one of the following actions: initiation of a new application, change of an application view, change to a new menu, or an input from a user of the electronic device.

5. An electronic device according to claim 1, wherein the control unit is arranged to store in a memory in the electronic device binding information between the touch sensitive area and the software function of a newly defined association, and
the control unit is arranged to define the association on the basis of the stored binding information.

6. An electronic device according to claim 1, wherein the control unit is further arranged to display an indication of the software function on the display.

7. An electronic device comprising:
means for detecting an input to a touch sensitive area and
means for performing a software function associated with the touch sensitive area, wherein there is a level difference between a surface of a body portion and a surface of a display, and the touch sensitive area is adapted between the body portion and the display to provide at least part of the level difference, the main direction of the surface of the touch sensitive area being substantially different from that of the body portion and/or the display.

8. A hardware module comprising
a connector for connecting the hardware module to the electronic device, and
a touch sensitive area for arrangement between a body portion and a display, the touch sensitive area being adaptable to providing a level difference between the surface of the body portion and the surface of the display such that the main direction of the surface of the touch sensitive area is substantially different from that of the body portion and/or the display.

9. A hardware module according to claim 8, wherein the hardware module is configured to receive an input to the touch sensitive area, and
the hardware module is configured to indicate the reception to a control unit for performing a software function associated with the touch sensitive area.

10. A user interface comprising:
a display,
a body portion, and
a touch sensitive area outside the display, wherein the touch sensitive area is arranged between the body portion and the display for providing a level difference between the surface of the body portion and the surface of the display, wherein the main direction of the surface of the touch sensitive area is substantially different from that of the body portion and/or the display.

11. A user interface according to claim 10, wherein the user interface is configured to receive an input to the touch sensitive area, and
the user interface is configured to indicate the reception to a control unit for performing a software function associated with the touch sensitive area.

12. An electronic device according to claim 2, wherein the touch sensitive area is associated with a shortcut to a view and/or an application, and
the control unit is configured to display the view and/or to initiate the application as a response to detecting the input to the touch sensitive area.

13. An electronic device according to claim 7, wherein the electronic device comprises means for determining the software function in response to entering or to a need to enter an operating state enabling detection of inputs to the touch sensitive area,
means for associating the determined software function with the touch sensitive area, and
means for removing the association in response to ending or exiting the operating state enabling detection of inputs to the touch sensitive area.

14. An electronic device comprising a control unit, a touch display and a touch sensitive area adjacent to and separate to the touch display, wherein the touch display and the touch sensitive area are arranged to allow continuous user input to the touch display and touch sensitive area.
